(19) United States
(12) Patent Application Publication
(10) Pub. No.: US 2001/0015716 A1
(43) Pub. Date: Aug. 23, 2001

(54) LIQUID CRYSTAL DISPLAY AND A METHOD FOR DRIVING THE SAME

(76) Inventor: DONG-GYU KIM, SUNKYUNG (KR)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/164,392

(22) Filed: Sep. 30, 1998

(30) Foreign Application Priority Data
Sep. 30, 1997 (KR) 97-49956

(51) Int. Cl. G09G 3/36

(52) U.S. Cl. 345/96

(57) ABSTRACT

Disclosed is a liquid crystal display and a method for driving the same. In the method, the data voltage representing image signals are applied to a plurality of pixels arranged in columns and rows, and the polarity of the data voltage for common voltage inverts the pixel groups comprised of two or more pixels. The inventive LCD includes a substrate, a plurality of gate lines formed on the substrate, a plurality of data lines insulated from and intersecting the gate lines, and a plurality pixels formed corresponding to respective regions defined by the data lines and gate lines. Common voltage is applied to the plurality of pixels, and the polarity of the data voltage for the common voltage inverts in units of pixel groups comprised of two or more pixels.

### BACKGROUND OF THE INVENTION

(a) Field of the Invention

The present invention relates to a liquid crystal display (LCD). More particularly, the present invention relates to an LCD and a method for driving the same in which a difference in brightness between adjacent pixels, caused by coupling capacitance between pixel electrodes of an LCD panel and adjacent data lines, is removed by a signal process of data voltage, and in which pixel defects caused by the shorting of one or two pixels is prevented.

(b) Description of the Related Art

LCDs are increasingly being used for the display device in televisions, personal computers, projection-type displays, etc. LCDs are significantly lighter in weight and slimmer, and consume far less energy than the previous-generation cathode-ray tube displays.

LCDs apply an electric field to liquid crystal material having anisotropic dielectricity and injected between two substrates, an array substrate and a counter substrate, arranged substantially parallel to one another with a predetermined gap therebetween, and control the amount of light permeating the substrates by controlling an intensity of the electric field to obtain a desired image signal.

Formed on the array substrate are a plurality of gate lines disposed parallel to one another, and a plurality of data lines insulated from and crossing the gate lines. A plurality of pixel electrodes are formed corresponding to respective regions (hereinafter referred to as “pixel”) defined by the data lines and gate lines. Further, a thin film transistor (TFT) is provided near each of the intersections of the gate lines and the data lines. Each pixel electrode is connected to a data line via a corresponding TFT, the TFT serving as a switching device therebetween.

Each TFT has a gate electrode, drain electrode, and a source electrode. The gate electrode is connected to one of gate lines, and the source electrode is connected to one of data lines and the drain electrode is connected to one of pixel electrodes. Common electrodes are disposed on either the array substrate or the counter substrate.

The operation of the LCD panel structured as in the above will be described hereinafter.

First, after gate ON voltage is applied to the gate electrodes connected to one of the gate lines to turn on the TFTs, data voltage representing image signals is applied to the source electrodes via the data lines such that the data voltage is applied to the pixel electrodes through TFT channels, and an electric field is created by a potential difference between the pixel electrodes and the common electrodes. The electric field intensity is controlled by a level of the data voltage, and the amount of light permeating the substrates is determined by the electric field intensity.

In the above, as the liquid crystal material degrades if the electric field is applied to the liquid crystal material continuously in the same direction, the direction in which the electric field is applied must be constantly changed. Namely, pixel electrode voltage (data voltage) values for the common electrodes must be alternated between positive and negative values.

Such switching of electrode voltage values between positive and negative values is referred to as an inversion driving method. Among the different types of inversion driving methods are frame inversion, line inversion, dot inversion, and column inversion.

In frame inversion, a polarity of pixel electrode voltage for the common electrode voltage is changed to cycles of frames. However, because of this converting of pixel electrode voltage polarity into units of frames, residual image or flick may occur. In line inversion, the polarity of pixel electrode voltage for the common electrode voltage is changed to horizontal cycles. However, crosstalk results when performing line inversion drive by the occurrence of voltage fluctuations between coupling capacitances realized between the data lines and common electrodes, and between the pixel electrodes and common electrodes.

Because of these drawbacks, the dot or column inversion driving methods are now more commonly used in LCDs.

Referring to FIGS. 1a and 1b, shown respectively are views of the prior art dot inversion driving method and the prior art column inversion driving method. In the drawings, (+) indicates positive pixel voltage for the common voltage, while (−) indicates negative pixel voltage for the common voltage.

As shown in FIG. 1a, polarities of any two adjacent pixels are different in the dot inversion driving method, while in the column inversion driving method, as shown in FIG. 1b, pixels having like polarities are arranged in the same column, with the polarities of the columns alternating from positive to negative.

In the above dot and column inversion drive methods, when the pixels in each row refresh, the number of pixels applied to data voltage having a positive polarity is the same as the number of pixels applied to data voltage having a negative polarity. Accordingly, voltage fluctuations between the coupling capacitance of the data lines and common electrodes and that of the pixel electrodes and common electrodes are prevented.

However, in the above-described dot and column inversion driving methods, while in theory they appear effective, in the actual patterning process of the pixel electrodes and data lines, misalignment and differences in widths occur. As a result, coupling capacitances between the pixel electrodes and adjacent data lines become dissimilar.

Referring now to FIG. 2, shown is a view illustrating misalignment between pixel electrodes and data lines in the prior art inversion driving methods shown in FIGS. 1a and 1b. Such misalignment and differences in widths generally occur when the substrates are separated and divided into a plurality of spheres for the patterning process.

In the drawing, Pa and Pb are pixel electrodes, disposed adjacent to but separated from one another, and Vp-a and Vp-b are voltage signals for the pixel electrodes Pa and Pb, respectively. Here, voltage signal Vp-a applies negative voltage for common electrode voltage, while voltage signal Vp-b applies positive voltage.

Although it is designed for the pixel electrodes Pa and Pb to have identical distances from data lines D1, D2, and D3, this is not the case with the actual resulting pattern as the distances between the data lines D1, D2, and D3 and the pixel electrodes Pa and Pb become dissimilar from misalignment and differences in widths of these elements. Because of this variation in distances, coupling capacitance values between the pixel electrodes Pa and Pb, and the data lines D1, D2, D3, and D4 differ.

For example, if the pixel electrode Pa is disposed slightly to the left (in the drawing), while the pixel electrode Pb is disposed slightly to the right (in the drawing), the following results in their coupling capacitance values: Ca-d1>Ca-d2 and Cb-d2 <Cb-d3. Here, Ca-d1 and Ca-d2 are the coupling capacitances between the pixel electrode Pa and the data lines D1 and D2, respectively, and Cb-d2 and Cb-d3 are the coupling capacitances between the pixel electrode Pb and the data lines D2 and D3, respectively.

Referring now to FIG. 3, shown is an equivalent circuit diagram for demonstrating influence given to the pixel electrode Pa by voltage fluctuations Vd1 and Vd2 of the data lines D1 and D2, respectively, and the coupling capacitances Ca-d1 and Ca-d2. In the drawing, Vp indicates voltage of the pixel electrode Pa, and Cl indicates liquid crystal capacitance. Here, common electrode voltage is indicated by the grounded level in the drawing as it is a constant value, and storage capacitance is not considered in the circuit analysis to simplify the same. The following formula is established for such a circuit using the law of conservation of charge:

(Vd1-Vp)*Ca-d1+(Vd2-Vp)*Ca-d2=Cl*VP

$$Vp = \frac{{V}_{d1} * {C}_{a - d1} + {V}_{d2} * {C}_{a - d2}}{{C}_{a - d1} + {C}_{a - d2} + {C}_{l}}$$

As liquid crystal capacitance is generally much larger than coupling capacitance, the above formula is simplified to an approximate formula as in the following:

$$Vp = \frac{{V}_{d1} * {C}_{a - d1} + {V}_{d2} * {C}_{a - d2}}{{C}_{l}}$$

As can be seen with the above formula, Vp is influenced more by the data voltage with the larger coupling capacitance.

Referring to FIG. 4, shown is a view illustrating fluctuations in voltage with respect to time when dot or column inversion drive is performed on the pattern shown in FIG. 2.

Since Ca-d1>Ca-d2 as described above, more influence is given by Vd1 than Vd2, and, accordingly, Vp-a is pulled toward a voltage side of Vd1. Further, as Cb-d2<Cb-d3, more influence is given by Vd3 than Vd2 such that Vp-b is pulled toward a voltage side of Vd3.

Namely, in FIG. 4, although an original value of Vp-a should be uniformly smaller than the common voltage as can be seen by the dotted line in the drawing, it is in actual application pulled toward Vd1 by the coupling capacitance. In the same way, although an original value of Vp-b should be uniformly larger than the common voltage, it is pulled toward Vd3.

Accordingly, a root mean square (RMS) of Vp-a becomes smaller than an original value, while a RMS of Vp-b becomes greater than an original value such that the brightness of the two pixels changes.

Further, as shown in FIG. 5a, according to the prior art dot and column inversion driving methods, Vp-a becomes a negative value for common voltage (Vcom), and Vp-b becomes a positive value in a normal state such that a black state is displayed. However, as shown in FIG. 5b, if electrodes of two adjacent electrodes are shorted, Vp-a and Vp-b become an average value of two voltages to become similar to the common voltage, resulting in the two pixels constantly displaying a white state, indicative of defective pixels.

### SUMMARY OF THE INVENTION

The present invention has been made in an effort to solve the above problems.

It is an object of the present invention to provide a liquid crystal display and a method for driving the same in which a difference in brightness between adjacent pixels, caused by coupling capacitance between pixel electrodes of a LCD panel and adjacent data lines, is removed by a signal process of data voltage, and in which pixel defects caused by the short of one or two pixels is prevented.

To achieve the above object, the present invention provides a liquid crystal display and a method for driving the same. In the method, the data voltage representing image signals are applied to a plurality of pixels arranged in columns and rows, and the polarity of the data voltage for common voltage inverts in units of the pixel groups being comprised of two or more pixels.

The inventive LCD includes a substrate, a plurality of gate lines formed on the substrate, a plurality of data lines insulated from and intersecting the gate lines, and a plurality pixels formed corresponding to respective regions defined by the data lines and gate lines.

Common voltage is applied to the plurality of pixels, and the polarity of the data voltage for the common voltage inverts in units of pixels groups being comprised of two or more pixels.

### BRIEF DESCRIPTION OF THE DRAWINGS

Further objects and other advantages of the present invention will become apparent from the following description in conjunction with the attached drawings, in which:

FIG. 1a is a view of the conventional dot inversion driving method;

FIG. 1b is a view of the conventional column inversion driving method,

FIG. 2 is a view illustrating misalignment between pixel electrodes and data lines in the prior art inversion driving methods shown in FIGS. 1a and 1b;

FIG. 3 is an equivalent circuit diagram for demonstrating influence given to a pixel electrode by voltage fluctuations and coupling capacitance;

FIG. 4 is a view illustrating fluctuations in voltage with respect to time when the pattern shown in FIG. 2 is dot or column-inversion driven;

FIG. 5a is a view illustrating data voltage applied to pixels shown in FIG. 2 when the same are in a normal state;

FIG. 5b is a view illustrating data voltage applied to the pixels shown in FIG. 2 when the same have been shorted;

FIGS. 6a and 6b are views illustrating inversion driving methods according to a preferred embodiment of the present invention;

FIG. 7 is a view illustrating misalignment between pixel electrodes and data lines in the inversion driving methods shown in FIGS. 6a and 6b;

FIG. 8 is a view illustrating fluctuations in voltage with respect to time when the pattern shown in FIG. 7 is driven using the inventive inversion method;

FIG. 9 illustrates data voltage applied to pixels shown in FIG. 7 when the same are in a normal state and when the same have been shorted;

FIG. 10 is a view illustrating a pixel structure according to a preferred embodiment of the present invention; and

FIG. 11 is a modified example of the pixel structure shown in FIG. 10 in which an in-plane switching mode is applied.

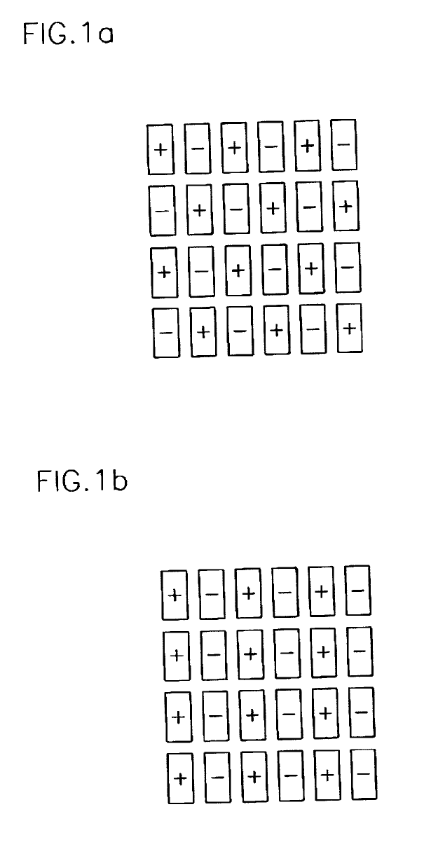

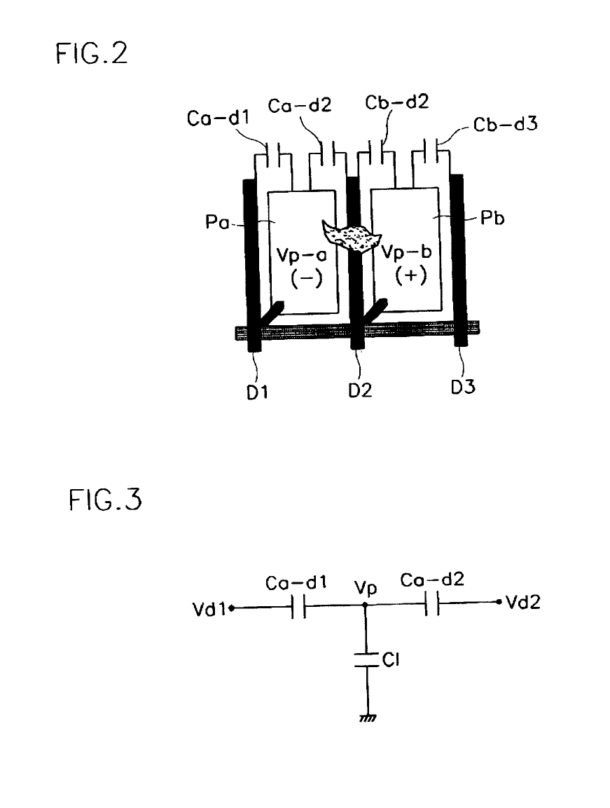

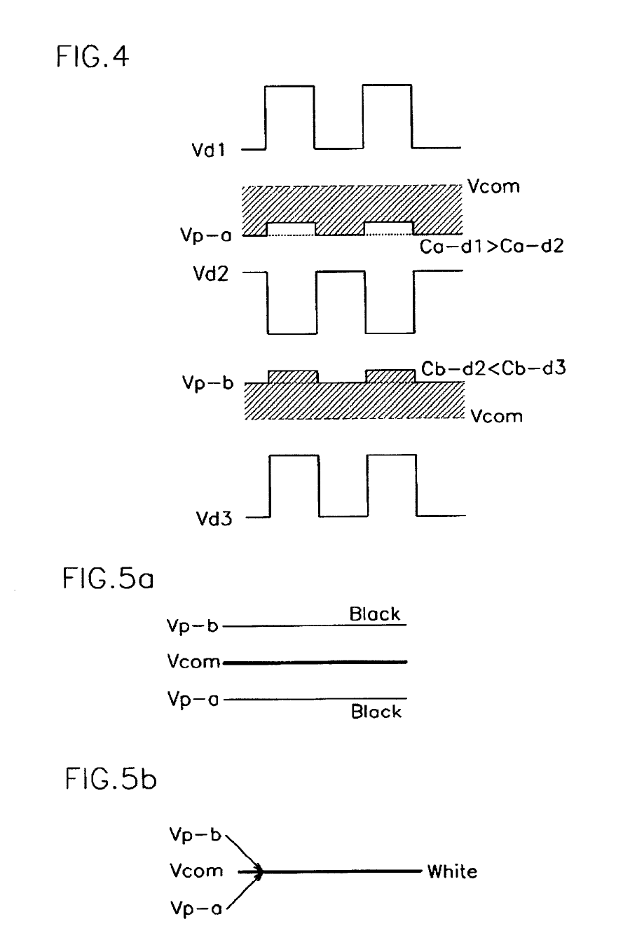

### DETAILED DESCRIPTION OF THE PREFERRED EMBODIMENTS

A preferred embodiment of the present invention will now be described in detail with reference to the accompanying drawings.

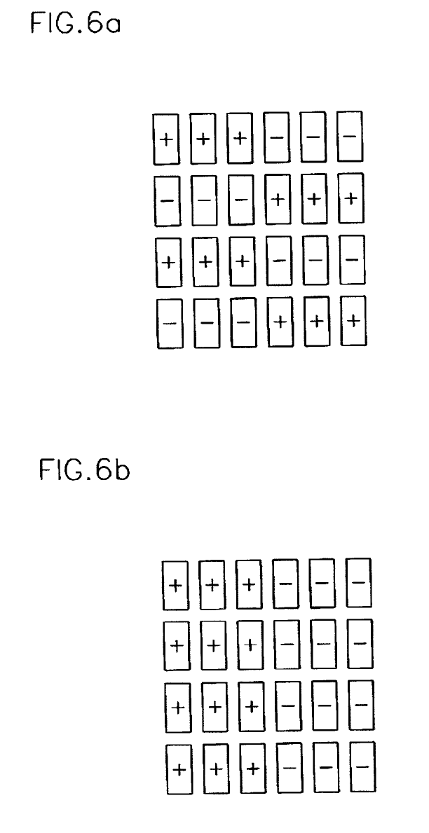

Referring first to FIGS. 6a and 6b, shown are views illustrating inversion driving methods according to a preferred embodiment of the present invention.

As shown in FIG. 6a, polarities of pixels for common voltage are inverted in units of pixel groups comprised of three pixels in each row for common voltage, and alternate between positive and negative in each column. The pixels in the pixel group are red (R), green (G), and blue (B) pixels, respectively. The inventive LCD is operated similarly to the dot inversion method such that the pixels are driven in units of RGB pixel groups.

In FIG. 6b, the polarities of the pixels for common voltage are identical in each column but are inverted as in units of pixel groups comprised of three pixels in each. That is, the LCD is operated similarly to the column dot inversion method such that the pixels are driven in units of RGB pixel groups in like columns.

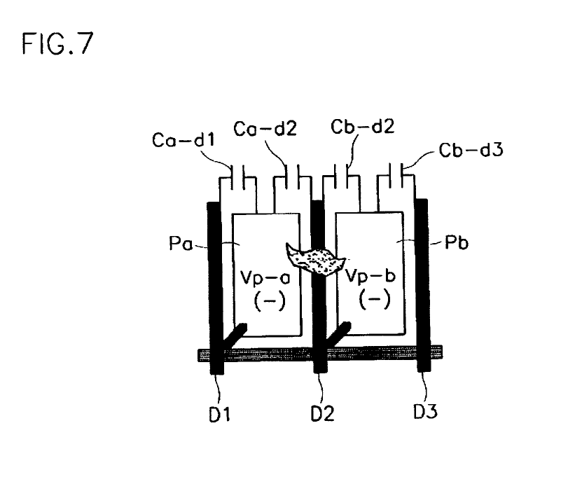

Referring to FIG. 7, shown is a view illustrating misalignment between pixel electrodes and data lines in the inversion driving methods shown in FIGS. 6a and 6b.

In the drawing, Pa and Pb are pixel electrodes, disposed adjacent to but separated from one another, and Vp-a and Vp-b are voltage signals for the pixel electrodes Pa and Pb, respectively. Here, voltage signals Vp-a and Vp-b apply negative voltage.

In the above, if the pixel electrode Pa is disposed slightly to the left (in the drawing), while the pixel electrode Pb is disposed slightly to the right (in the drawing) with respect to data lines D1, D2, and D3, the following results in their coupling capacitance values: Ca-d1>Ca-d2 and Cb-d2<Cb-d3. Here, Ca-d1 and Ca-d2 are the coupling capacitances between the pixel electrode Pa and the data lines D1 and D2, respectively, and Cb-d2 and Cb-d3 are the coupling capacitances between the pixel electrode Pb and the data lines D2 and D3, respectively.

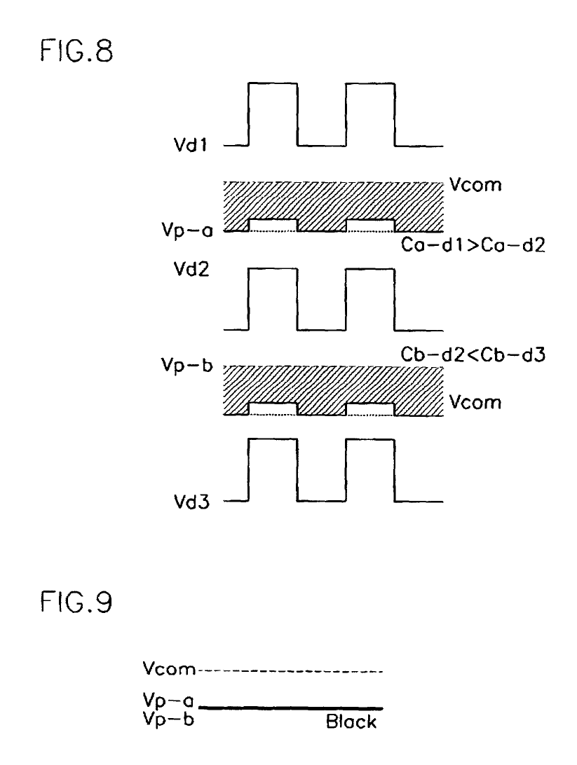

Referring to FIG. 8, shown is a view illustrating fluctuations in voltage with respect to time when inversion drive according to the present invention is performed on the pattern shown in FIG. 7. Here, it is assumed that pixel voltage is influenced more by data voltage with a larger coupling capacitance.

Accordingly, as Ca-d1>Ca-d2, more influence is given to pixel voltage Vp-a of the pixel Pa by Vd1 than Vd2 such that Vp-a is pulled upward (in the drawing) as a result of Vd1 and Vd2 moving in an identical phase. Further, as Cb-d2<Cb-d3, more influence is given to pixel voltage Vp-b of the pixel Pb by Vd3 than Vd2 such that Vp-b is pulled upward (in the drawing) as a result of Vd3 and Vd2 moving in an identical phase.

Namely, the pixels Vp-a and Vp-b do not result in the dotted line shown in FIG. 8, but as they are shifted in an identical direction by coupling capacitance, a root mean square (RMS) of two adjacent pixels becomes nearly identical. Accordingly, a difference in brightness of adjacent pixels (i.e. between pixels in the RGB groups) does not result as in the prior art.

Further, according to the inversion driving method of FIGS. 6a and 6b, as shown in FIG. 9, Vp-a and Vp-b become negative values for common voltage (Vcom) in a normal state such that a black state is displayed. In addition, as Vp-a and Vp-b become negative values even if electrodes of two adjacent pixels are shorted, a black state is displayed as in a normal state. Accordingly, in the inventive LCD, pixels do not become defective to display a white state even in the case where two adjacent pixels are shorted.

In FIGS. 6a and 6b, although the number of pixels in the pixel group is three, the number of pixels in the pixel group is not limited to this number.

Further, in the inventive LCD, although a difference in brightness results between adjacent pixels of differing RGB groups from coupling capacitances as in the prior art dot and column inversion driving methods, in addition to pixel defects resulting from the shorting of pixels, there is a one-third reduction in the probability that such problems will occur in the present invention.

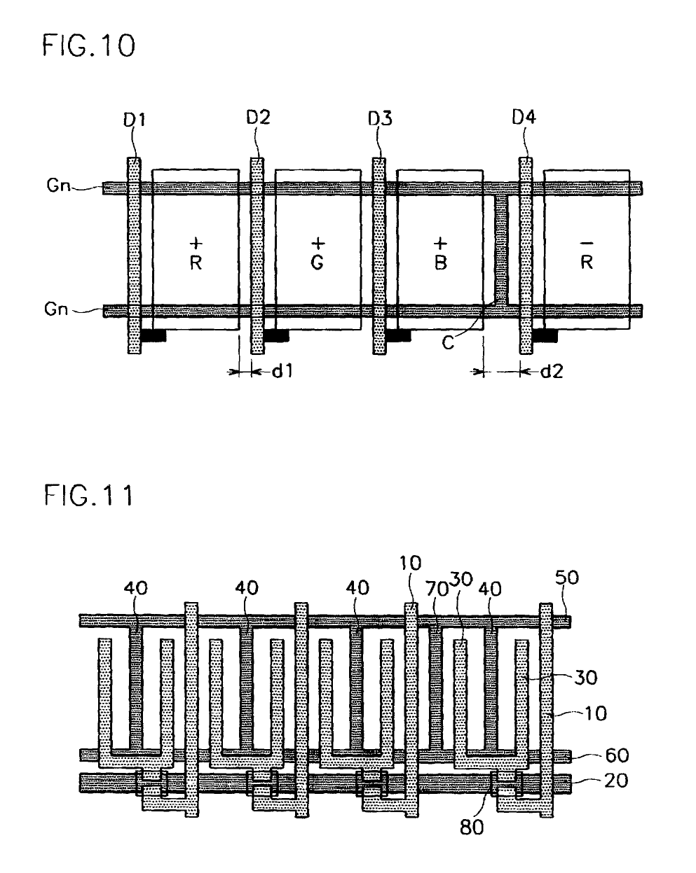

Accordingly, to prevent the above problems of brightness discrepancies between adjacent pixels of differing RGB groups and defects of pixels, an inventive pixel structure is provided as shown in FIG. 10.

In the drawing, a sufficient distance d2 is provided between a blue (B) pixel electrode and a data line D4 provided to the right (in the drawing) of the same pixel electrode, while a distance d1 between data lines D1, D2, and D3 and red (R), green (G), and blue (B) pixel electrodes is maintained to as small a degree as possible.

With the enlarging of the distance d2 between the blue (B) pixel electrode and the data line D4 (before the next group of RGB pixels), as coupling capacitance is reduced between these two elements, a difference in brightness caused by coupling capacitance is reduced, and the probability that adjacent pixels of two RGB groups are shorted is minimized. Also, by the sufficient distance d2 provided as in the above, cutting using a laser, etc. is easy when a short occurs.

However, by the making of such a large interval between a pixel and data line, as an aperture ratio is reduced, only one pixel electrode out of each RGB group of three pixels has this large distance d2 with a data line, while the remaining two pixels has the distance d1 with the data lines. According to the present invention, it is preferable that the distance d2 is from two to six times larger than the distance d1, with the most preferable multiple being four.

When two gate lines, a first gate line Gn and a second gate line Gn′, are provided, if a connecting member C is formed between the gate lines Gn and Gn′, differences in brightness caused by coupling capacitance between adjacent pixels of different RGB groups is further prevented.

In more detail, because gate OFF voltage, generally lower than data voltage, is mainly applied to the connecting member C, electrical shielding is provided between the pixel electrode and the data line D4 such that coupling capacitance is reduced, thereby preventing differences in brightness between pixels from occurring. Here, it is preferable that the connecting member C is interposed between two pixels of different RGB groups.

The above method of disposing a connecting member between gate lines and between adjacent pixel electrodes of different groups to prevent differences in pixel brightness can also be applied to an in-plane switching (IPS) mode.

Referring to FIG. 11, shown is a modified example of the pixel structure shown in FIG. 10 in which the IPS mode is applied. As shown in the drawing, a TFT 80 having a source electrode, drain electrode, and gate electrode is provided near each of intersection of data lines 10 and a gate line 20, and two pixel electrodes 30 are merged and connected to each of the drain electrodes of the TFTs 80. A first common line 50 and a second common line 60 are arranged parallel to the gate line 20, and common electrodes 40 connect the first and second common lines 50 and 60. The common electrodes 40 are positioned between each pair of pixel electrodes 30.

A connecting member 70 is further provided between the first and second common lines 50 and 60, at a location where pixel electrodes 30 of different RGB groups are adjacent. The connecting member 70, as in the pixel structure shown in FIG. 10, provides electrical shielding between the pixel electrodes 30 and data lines 10. Namely, as common voltage is applied to the connecting member 70, coupling capacitance is reduced between the pixel electrodes 30 and data lines 10 such that differences in brightness between pixels of different groups is prevented. Here, it is preferable that the connecting member is interposed between two pixels of different RGB groups.

In the present invention, differences in brightness between adjacent pixels, caused by coupling capacitance between pixel electrodes and adjacent data lines, is reduced, and pixel defects caused by the short of two pixels is prevented.

Other embodiments of the invention will be apparent to the skilled in the art from consideration of the specification and practice of the invention disclosed herein. It is intended that the specification and examples be considered as exemplary only, with the true scope and spirit of the invention being indicated by the following claims.

What is claimed is:

1. A method for driving a liquid crystal display in which common voltage and data voltage, representing image signals, are applied to a plurality of pixels arranged in columns and rows,
wherein the polarity of data voltage for the common voltage inverts in units of groups, the pixel groups being comprised of two or more adjacent pixels.

2. The method according to claim 1, wherein the pixel groups are comprised of three pixels.

3. The method according to claim 2, wherein the pixel groups are comprised of a red pixel, a green pixel, and a blue pixel.

4. The method according to claim 1, wherein data voltages having the same polarity for the common voltage are applied to the adjacent pixels in the same column.

5. The method according to claim 1, wherein the data voltages having different polarities for the common voltage are applied to the adjacent pixels on the same column.

6. A liquid crystal display comprising:
a substrate;
a plurality of gate lines formed on the substrate;
a plurality of data lines insulated from and intersecting the gate lines; and
a plurality pixels formed corresponding to respective regions defined by the data lines and gate lines,
wherein common voltage is applied to the plurality of pixels, and the polarity of the data voltage for the common voltage inverts in units of pixel groups, the pixel groups being comprised of two or more pixels.

7. The LCD according to claim 6, wherein the pixel groups are comprised of three pixels.

8. The LCD according to claim 7, wherein the pixel groups are comprised of a red pixel, a green pixel, and a blue pixel.

9. The LCD according to claim 6, wherein a distance d2 between a first data line adjacent to the pixel group and a pixel adjacent to the first data line is two to six times larger than a distance d1 between a second data line in the pixel group and the pixel adjacent to the second data lines.

10. The LCD according to claim 9, wherein the distance d2 is four times the distance d1.

11. The LCD according to claim 6, where the gate lines are arranged in groups of two, a first gate line and a second gate line, and a connecting member is formed between the first and second gate lines.

12. The LCD according to claim 11, wherein the connecting member is interposed between pixels of different pixel groups.

13. The LCD according to claim 6, wherein the common voltage is applied through a common electrode formed on the substrate.

14. The LCD according to claim 13, wherein common lines, applying the common voltage, are connected to the common electrode, the common lines comprising first and second common lines, and a connecting member connects the first and second common lines.

15. The LCD according to claim 14, wherein the connecting member is interposed between pixels of different pixel groups.
